(19) United States
(12) Patent Application Publication
(10) Pub. No.: US 2016/0017657 A1
(43) Pub. Date: Jan. 21, 2016

(54) SEGMENTED COLLAPSIBLE LADDER

(71) Applicant: Aluma Systems Inc., Toronto (CA)

(72) Inventor: STEPHEN WILSON, Toronto (CA)

(21) Appl. No.: 14/331,441

(22) Filed: Jul. 15, 2014

(51) Int. Cl. E06C 1/30

(52) U.S. Cl. CPC E06C 1/30

(57) ABSTRACT

A ladder assembly includes a plurality of interconnected ladder segments. Each ladder segment comprises two opposing rails and rungs that are pivotably mounted to the rails to allow each ladder segment to be collapsed by pivoting the rungs in a folding direction relative to the rails and moving opposing rails closer to each other. Each ladder segment may be erected by pivoting the rungs in an opposite unfolding direction relative to the rails. Ladder segments further comprise top and bottom rail connectors allowing interconnection of the top of that ladder segment to the bottom of another of the ladder segments. The top and bottom rail connectors are keyed, so that first and second connected ones of said plurality of ladder segments will be oriented with the unfolding direction of their rungs opposite to each other.

### FIELD

This invention relates to ladders, and more specifically to collapsible ladders that may be installed in confined areas, and areas with limited access.

### BACKGROUND

Ladders are often difficult to transport, and more difficult to place in confined areas. As such, a variety of ladder designs that serve to limit space used by a ladder exist. For example, folding and telescoping ladders are common. Likewise, segmented ladders are known. Each of these designs serves to reduce the length of the ladder in certain configurations.

The width of a ladder is more difficult to reduce. Nevertheless, collapsible ladders, in which opposing ladder rails may be moved toward or away from each other, are also known. One such design allows the ladder rungs to pivot while the rails are moved laterally.

Of course a collapsible ladder is typically inherently less stable than its non-collapsible counterpart.

Accordingly, there is a need for an improved collapsible ladder.

### SUMMARY

According to an aspect, there is provided a ladder assembly, comprising: a plurality of ladder segments. Each ladder segment includes two opposing rails and rungs pivotably mounted to the rails to allow each ladder segment to be collapsed by pivoting the rungs in a folding direction relative to the rails and moving the opposing rails closer to each other. Each segment must be erected by pivoting the rungs in an unfolding direction relative to the rails and moving the opposing rails away from each other. Each ladder segment further includes top and bottom rail connectors allowing interconnection of the top of a ladder segment to the bottom of another one of the plurality of ladder segments. The top and bottom rail connectors are keyed, so that first and second connected ones of the plurality of ladder segments will be oriented with the unfolding direction of their rungs opposite to each other, when assembled.

An exemplary method of assembling a ladder assembly comprises connecting the plurality of ladder substantially identical segments to each other by way of their top and bottom rail connectors so that connected ones of the plurality of ladder segments will be oriented with the unfolding direction of their rungs opposite to each other.

Other features will become apparent from the drawings in conjunction with the following description.

### BRIEF DESCRIPTION OF THE DRAWINGS

In the figures which illustrate embodiments by way of non-limiting examples,

FIG. 1 is a perspective view of a ladder assembly, installed in a passageway, with the passageway shown in cut-away

FIG. 2 is a front view of a ladder segment used of the ladder assembly of FIG. 1, in an erect configuration;

FIG. 3 is front view of the ladder segment of FIG. 2 in a collapsed configuration;

FIGS. 4A and 4B are enlarged views of portions of the ladder segment of FIGS. 3 and 4;

FIG. 5 is a perspective view of two ladder segments of FIGS. 2 and 3;

FIG. 6 is a top view of the ladder assembly installed in the passageway of FIG. 1;

FIG. 7 is a bottom plan view of a ladder segment of FIG. 5;

FIGS. 8A-8D are schematic views of the installation of the ladder assembly of FIG. 1 in a passageway; and

FIG. 9 is a cross-sectional view of the passageway of FIG. 1, with ladder assembly installed.

### DETAILED DESCRIPTION

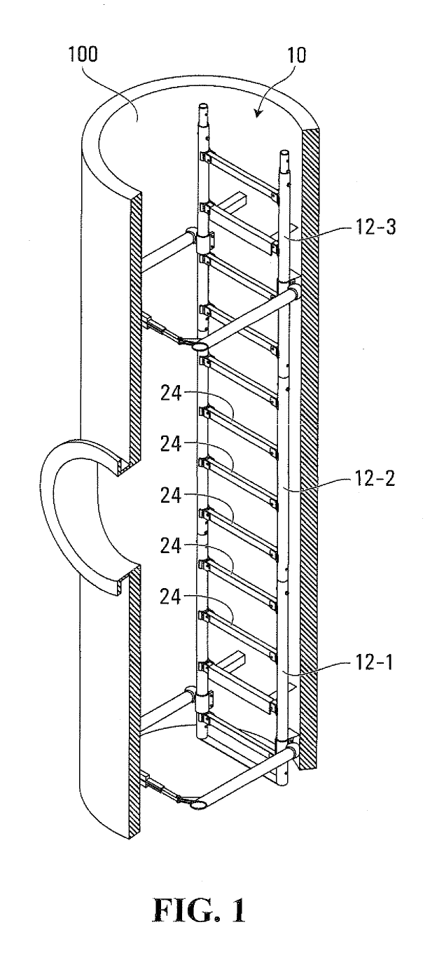

FIG. 1 is a perspective view of an exemplary ladder assembly 10 located in a narrow passageway 100.

Ladder assembly 10 is formed of a plurality of ladder segments 12-1, 12-2 and 12-3 (individually and collectively ladder segment(s) 12). Each ladder segment 12 includes several rungs 24-1, 24-2, 24-3 . . . (individually and collectively rung(s) 24) and vertically extending rails 14a and 14b. As will become apparent, each ladder segment 12 is collapsible. That is, rails 14a and 14b may be moved laterally toward each other. Rungs 24 extend horizontally and are supported by vertically extending rails 14a and 14b of ladder segments 12, when segments 12 are erected. In this configuration, rungs 24 extend to orthogonally to rails 14a and 14b. In the depicted embodiment, each ladder segment 12 includes four rungs 24 that are spaced at equal vertical distances from each other.

Rungs 24 and rails 12 may be formed of suitable materials, such as steel, aluminum or fiberglass, or the like.

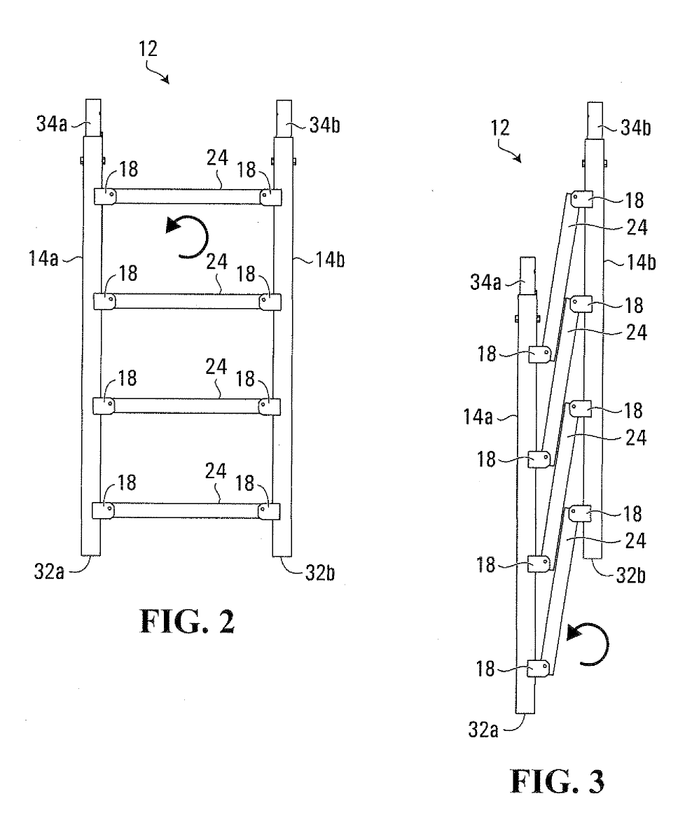

As illustrated in FIGS. 2 and 3, each ladder segment 12 may be collapsed (as shown in FIG. 3), and erected (as shown in FIG. 2). To allow each ladder segment 12 to collapse, rungs 24 are pivotably mounted to rails 14a and 14b, to allow each rung to rotate or pivot relative to each rail 14a, 14b, about an axis, normal to the horizontal extent of rungs 24, and normal to the vertical extent of rails 14a and 14b. Conveniently, the width of ladder segment 12 when collapsed is only a fraction of the width of ladder assembly 10. In the depicted embodiment, ladder segment 12 has a width of about 9 inches when collapsed or folded, and a width of about 20 inches when extended. As illustrated adjacent rungs 24 come into contact with each other when folded.

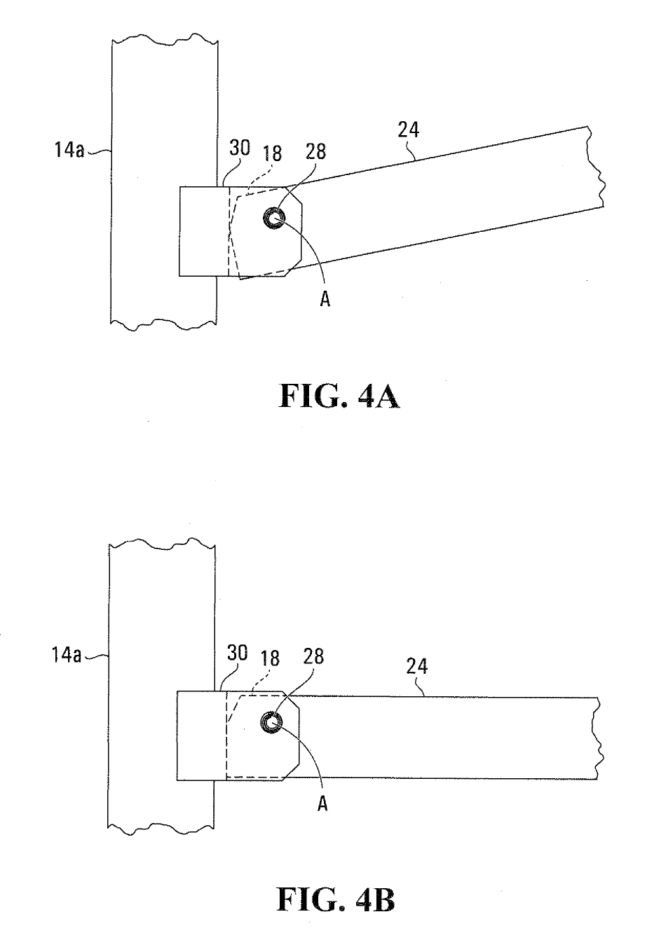

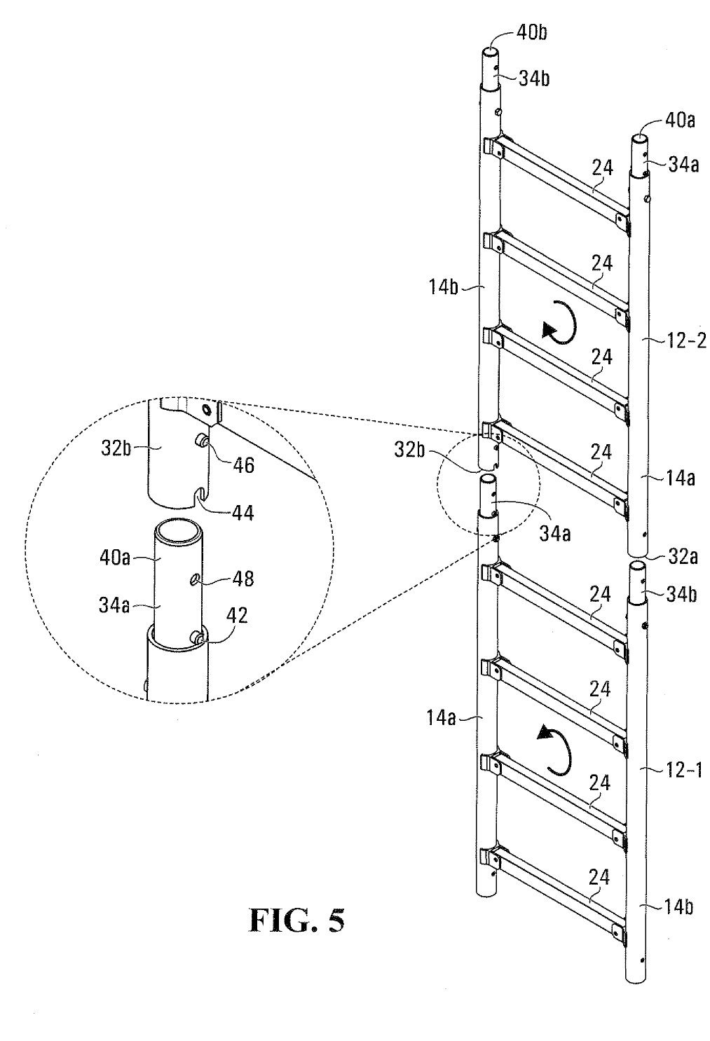

To allow pivoting of rungs 24 relative to rails 14a and 14b, rungs 24 may be mounted to rails 14a and 14b by way of brackets 18. Brackets 18 may be welded or otherwise affixed to rails 14a and 14b, and include two generally flat plates, defining a mounting slot for a rung 24, best seen in FIGS. 4A and 4B and 5. To that end, rungs 24 are generally rectangular in cross-section and slots defined by brackets 18 and rungs 24 are complementary in size. Rungs 24 may be mounted to each bracket 24 using a pivot pin 28. Pivot pin 28 may be formed by the unthreaded part of a machine bolt, or other suitable pin.

As illustrated in FIG. 3, a rung 24 rotates or pivots relative to rail 14a (hereinafter an A-Rail) about axis A, and about axis B, relative to rail 146 (hereinafter a B-Rail), on respective pivot pins 28.

Each rung 24 is mounted to a rail 14a or 14b so as to pivot past its horizontal orientation in only one direction. That is, for each rung, a stop on one (e.g. the A-rail) rail 14a prevents that rung 24 from pivoting downward beyond its horizontal extent (i.e. when erect), while a stop on the other (e.g. the B-rail) rail 14b prevents that rung 24 from pivoting upwardly relative to rail 14b, beyond its horizontal extent.

A stop may be formed as illustrated in FIGS. 4A and 4B. As illustrated, each bracket 18 may have a vertically extending edge 30 that abuts the edge of rung 24, when in its horizontal orientation. The top corner of each rung 24, proximate rail 14a, may be chamfered, sufficiently to allow pivoting of rung 24 about axis A, so that the vertical edge of rung 24 may be pivoted upward from horizontal orientation, but may not pivot downward beyond its horizontal orientation. Likewise, the bottom corner of each rung 24, proximate rail 14b, may be likewise chamfered (not shown), to allow to pivoting of rung 24 about axis B, so that the vertical edge of rung 24 abuts edge 30 when rung 24 is horizontal, but may not pivot upward beyond its horizontal orientation.

Conveniently then, in order to collapse segment from its erect configuration, with rungs 24 horizontal shown in FIG. 2, rungs 24 are pivoted in a folding direction (shown in FIG. 2), drawing rail 14b toward rail 14a. In order to erect a collapsed ladder segment 12, rungs 24 are pivoted in the opposite unfolding direction (shown in FIG. 3), urging rail 14b away from rail 14a, and urging rungs 24 into their horizontal orientation. In FIGS. 2 and 3, the folding and unfolding pivot directions are counter-clockwise and clockwise, respectively.

Of note, in FIGS, 2 and 3, ladder segment 12 is shown in an orientation with rail 14a to the left of rail 14b. If ladder segment 12 is reversed (or viewed from behind), with rail 14b to the left of rail 14a, folding and unfolding directions reverse, to clockwise and counter-clockwise, respectively.

Now, top ends of rails 14a, 14b of one ladder segment 12-1, may be connected to bottom ends of rails 14b, 14a of another ladder segment 12-2, so that a ladder of arbitrary length may be formed by connecting multiple segments 12, end to end. Conveniently, ladder segments 12 may be identical in construction, with four rungs each. Alternatively, ladder segments of varying length (and differing number of rungs) may be formed.

To allow interconnection of ladder segments 12, each rail 14a and 14b, may include rail connectors to connect that rail 14a, 14b to a rail 14b, 14a in a ladder segment immediately below or immediately above it. More specifically, rail 14a includes bottom and top rail connectors 32a and 34a. Rail 14a includes bottom and top rail connectors 32b and 34b. For reasons that will become apparent, rail connectors are keyed, so that the bottom of a rail 14a, relative to which rungs 24 pivot upwardly (e.g. and A-rail), may only be interconnected to the top of a rail 14b, relative to which rungs 24 pivot downwardly (e.g. a B-rail). Likewise, the bottom of a rail 14b, relative to which rungs 24 pivot upwardly (e.g. a A-rail), may only be interconnected to the top of a rail 14b, relative to which rungs 24 pivot downwardly (e.g. a B-rail). Put another way, rail connector 32a uniquely mates with rail connector 34b and rail connector 32b uniquely mates with rail connector 34a. In the depicted orientation of FIG. 2 the A-rail is the left rail and B-rail is the right rail.

In this way, the A-rail of one ladder segment 12-1 is interconnected with the B-rail of ladder segment 12-2, while the B-rail of segment 12-1 is interconnected with the A-rail of ladder segment 12-2. The resulting assembly segments 12-1 and 12-2 cannot be collapsed without disassembly, as rungs 24 of segment 12-1 must pivot in the opposite direction of rungs 24 of segment 12-2. Similarly, segment 12-3, is mounted atop segment 12-2 with the A-rail (rail 14a) of segment 12-3 mounted atop the B-rail (rail 14b) of segment 12-2; and the B-rail (rail 14a) of segment 12-3 mounted atop the A-rail (rail 14b) of segment 12-2. This provides for increased stability of ladder assembly 10 in use, preventing accidental collapse of assembly 10, resulting from the pivoting of rails 24. This interconnection is illustrated in FIG. 5 that shows two ladder segments 12-1 and 12-2 interconnected with each other. The folding direction of each ladder segment 12-1 and 12-2 is also is also illustrated.

Example rail connectors 32a, 32b and 34a, 34b are also illustrated in enlargement in FIG. 5. As illustrated, rail connectors 34a, 34b may take the form of spigots 40a and 40b extending upwardly from rails 14a and 14b. Rail connectors 32a, 32b may take form of complementary openings in the base of rails 14a and 14b, respectively. Spigots 40a and 40b may be hollow, and may house resiliently biased locking pins 46. Each pin 46 may be resiliently biased outward, away from a central axis of the rail 14a, 14b from which it extends. The bases of rails 14a and 14b may similarly be hollow. The wall of rails 14a and 14b may include complementary holes 46 that receive pins 46 when properly aligned, and urged therein as a result of outward resilient bias on pins 46.

Spigots forming connectors 32a and 32b may optionally have a different cross sectional profile from each other. For example, spigot 40a of connector 34a may be formed as a spigot having a larger cross-section than connector 34b. Alternatively, as illustrated, spigot 40a of rail connector 34a may have a radial protrusion, while spigot of rail connector 34b may not, as detailed below. Openings in the bases of rails 14a may have a complementary shape to respective spigots.

Notably, top rail connector 34a (or 34b) and bottom rail connector 32a (or 32b) of any one of rails 14a (or 14b) are not complementary connectors. Instead, the top rail connector 34a (or 34b) of a rail 14a (or 14b) in one ladder segment 12, is complementary to the bottom rail connector 32b (or 32a) of the other rail 14b (or 14a) in that ladder segment 12.

Spigot 40a includes a protrusion 42 that protrudes radially outward from spigot 40a. Protrusion 42 may take the form of a bar, a bump, or the like, and does not move relative to spigot 40a. Conversely, the complementary rail connector in base of rail 34b includes a mating slot 44, sized and positioned to receive protrusion 42. By contrast, the complementary rail connector in base of rail 34a includes no such slot. This is best viewed in FIG. 7. Likewise spigot 40b includes no protrusion, As such, if female mating connector of rail 34a engages spigot 40a, protrusion 42 will the bottom of rail 14a (without mating slot 44) from sliding to the bottom end of spigot 40a. As a consequence, pins 46 will not align with holes 48, preventing respective ladder segments (i.e. segments 12-1 and 12-2) from being properly assembled.

Other keyed mating arrangements for rail connectors 32a, 32b, 34a, 34b will be apparent to those of ordinary skill.

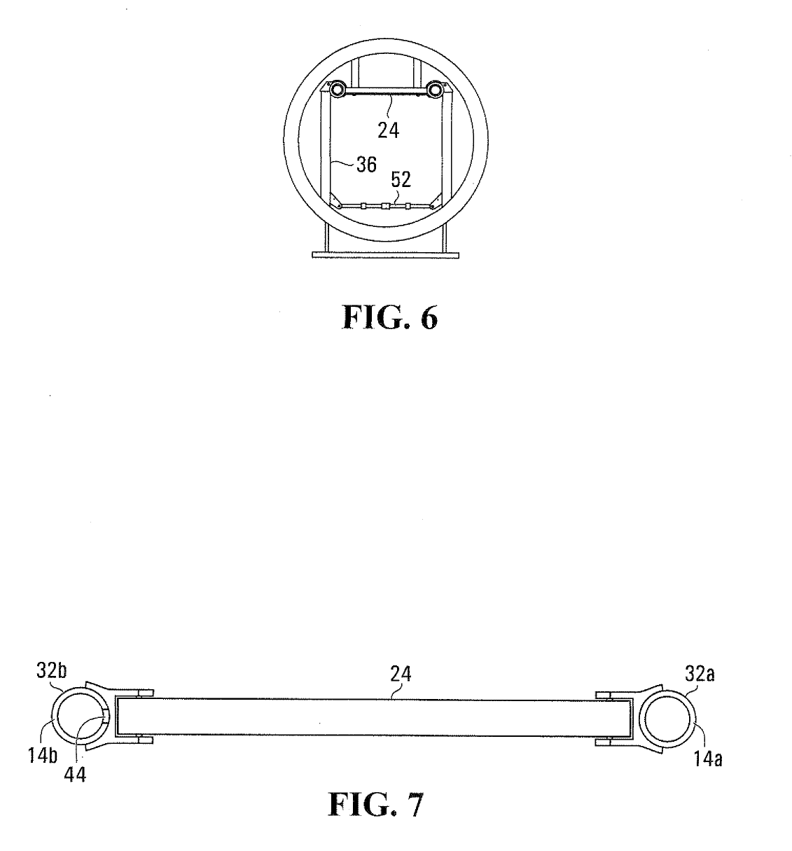

As illustrated in FIG. 1, ladder assembly 10 is particular well suited for use in a confined space such as a vertically extending passageway 100. Passageway 100 may take the form of circular conduit, and has a radius that is slightly larger than the width of ladder assembly 10 thereby allowing opposing rails 14a and 14b of assembly 10 to rest against points of passageway 100 that are spaced by less than 180° degrees. This is illustrated in FIG. 6.

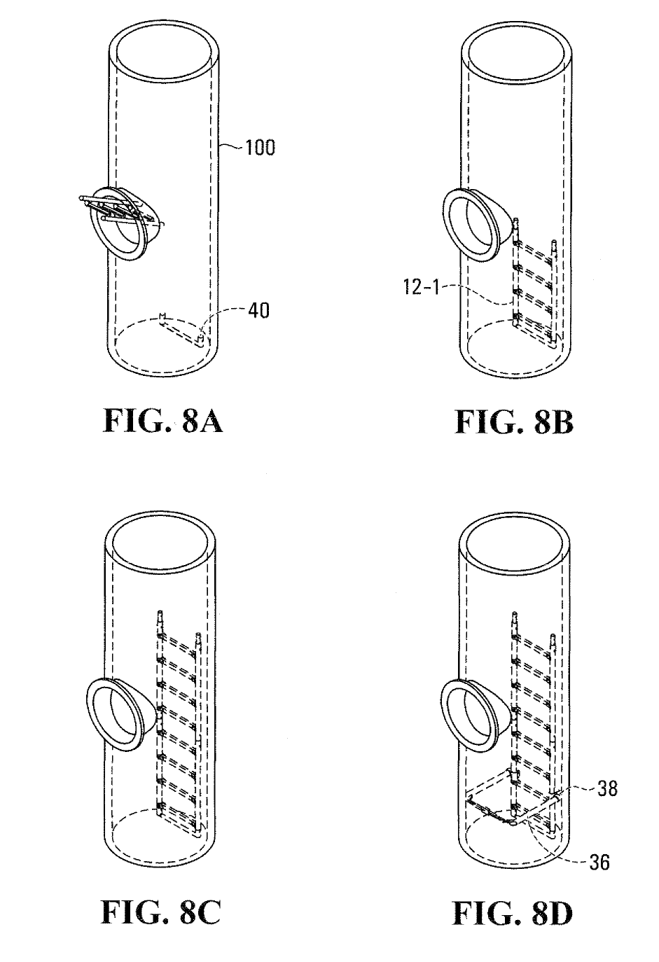

Individual ladder segments 12 may be transported through an opening like opening 110, that may be narrower that rungs 24. This is best illustrated in FIGS. 8A-8D.

To erect ladder assembly 10 within passageway 100, ladder segments 12 may be folded by pivoting rungs 24 toward rail 14a in a counter-clockwise direction. Rungs 24 similarly pivot clockwise relative to vertical rung 14b.

Folded ladder segments may be transported through opening 110 into passageway 100, as illustrated FIG. 8A. Conveniently, ladder segment 12 when folded/collapsed may be placed through a narrow opening 110 much narrower than passageway 100 as seen in FIGS. 8A-8D and FIG. 3. Conveniently, the size of the opening 110 maybe significantly smaller than the width of ladder assembly 10 and need only accommodate folded ladder segments 12. As noted, the folded width of each ladder segment 12 may only be a fraction of the width of ladder assembly 10, when erected.

As illustrated in FIG. 8A, a base 40 may optionally be initially placed on the bottom surface that is intended to support ladder assembly 10. Base 40 may take the form of a plate, with two vertically extending rail mounts, having the same form as rail connectors 34a and 34b (e.g. spigots 40a, 40b), allowing an initial ladder segment 12-1 to be mounted thereto. Base 40 may optionally be fastened to the floor on which ladder assembly 10 is to rest.

Once the initial ladder segment 12-1 is received, it may be placed on support 40 as illustrated in FIG. 8A. To do so, the ladder segment 12 is unfolded by bringing rail 14b downward toward rail 14a thereby orienting rungs 24 normal to vertical rails 14a and 14b. The base of vertical rails 14a and 14b may then be attached to complementary vertically extending supports (spigots) on base 40. Again, spigots on base 40 and rail connector 32a and 32b may be complementary. Once the initially ladder segment 12-1 is locked into place, the next ladder segment 12-2 may be placed atop of ladder segment 12-1.

As the top rail connectors 34a and 34b of ladder segment 12-1 and bottom rail connectors 32a and 32b are keyed, ladder segment 12-2 must be placed on ladder segment 12-1 so that rungs 24 pivot from a horizontal position to a vertical position in opposite rotation to the rungs of ladder segment 12-1. As such, ladder segments 12-1 and 12-2 oppose each other so is to prevent accidental folding of segments 12-1 and 12-2.

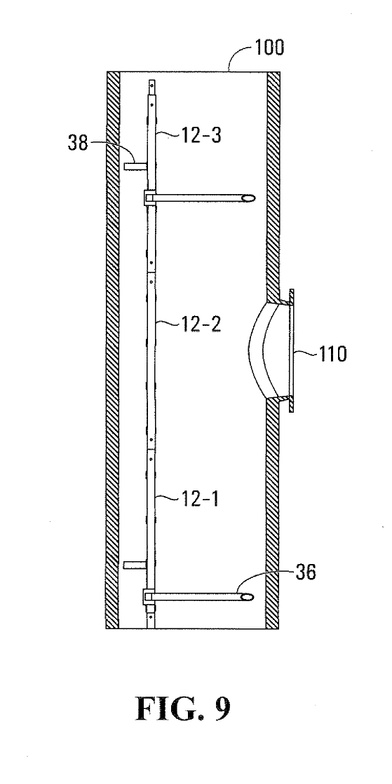

Once segments 12-1 and 12-2 are installed, forward and aft support segments 36 and 38 may be installed. Stabilizer 36 and 38 extent generally orthogonal to the plane of ladder rungs 24 and contact the outer wall of passageway 100 and as best illustrated in FIGS. 6 and 9. Segments 36 may extent forwardly from a ladder segment 12 by way of a stand-up sleeve that sits atop a rung of interest. Segment 36 may further include a turnbuckle 52 (FIG. 6) to allow the forwardly extending portions of segment 36 to be adjusted laterally against the inner wall of passageway 100. Stabilizer segment 38 may be formed of two bars that may be attached to the upstanding vertical rails 14a and 14b, and buttress rails 14a and 14b on the inner wall of passageway 100.

Additional ladder segments 12 (not specifically illustrated) may be installed atop ladder segment 12-2. Once again, because the top connectors of each segment 12 are keyed to the bottom connectors of other ladder segments 12, adjacent ladder segments in ladder assembly 10 will be installed so that the folding direction of each ladder segment is opposite to the folding direction of an adjacent ladder segment.

Segments 36 and 38 may be installed at suitable intervals—for example every 8 feet of ladder assembly 10, to further stabilize ladder assembly 10 within passageway 100.

As will be appreciated, ladder assembly 10 may be uninstalled, in the reverse order as it was installed.

As will further be appreciated, the described ladder assembly 10 has been illustrated as a vertically upstanding ladder assembly. However, ladder assembly 10 (or a similar ladder assembly) may be used as a leaning ladder assembly, or otherwise.

Of course, the above described embodiments are intended to be illustrative only and in no way limiting. The described embodiments are susceptible to many modifications of form, arrangement of parts, details and order of operation. The invention is intended to encompass all such modification within its scope, as defined by the claims.

1. A ladder assembly, comprising:
a plurality of ladder segments, each ladder segment comprising two opposing rails and rungs pivotably mounted to said rails to allow each ladder segment to be collapsed by pivoting the rungs in a folding direction relative to the rails and moving the opposing rails closer to each other, and erected by pivoting the rungs in an unfolding direction relative to the rails and moving the opposing rails away from each other;
each ladder segment further comprising top and bottom rail connectors allowing interconnection of the top of that ladder segment to the bottom of another one of said plurality of ladder segments;
wherein said top and bottom rail connectors are keyed, so that first and second connected ones of said plurality of ladder segments will be oriented with the unfolding direction of their rungs opposite to each other.

2. The ladder assembly of claim 1, wherein each of said rungs is mounted to one of said opposing rails by way of a bracket.

3. The ladder assembly of claim 2, wherein each of said rungs is mounted to a rail so as to pivot past its horizontal orientation in only one direction.

4. The ladder assembly of claim 2, wherein each said bracket includes a stop to abut a rung in its horizontal orientation.

5. The ladder assembly of claim 4, wherein a corner of each of said rungs is chamfered.

6. The ladder assembly of claim 1, wherein said top rail connectors extend from a top of a rail, and said bottom rail connectors comprise an opening in a bottom of said rail.

7. The ladder assembly of claim 6, wherein each of said top rail connectors comprises a spigot.

8. The ladder assembly of claim 7, where said each of said bottom rail connectors comprise an opening in a bottom of one of said rails.

9. The ladder assembly of claim 1, wherein the top rail connector and said bottom rail connector of any one of said rails are not complementary connectors.

10. The ladder assembly of claim 1, wherein the top rail connector of a rail in one ladder segment, is complementary to the bottom rail connector of the other rail in that ladder segment.

11. The ladder assembly of claim 1, further comprising a base, for receiving the bottom one of said plurality of ladder segments.

12. The ladder assembly of claim 11, wherein said base comprises top rail connectors for receiving the bottom one of said plurality of ladder segments.

13. The ladder assembly of claim 1, wherein said rungs and said rails are formed of at least one of aluminum, steel, and fiberglass.

14. The ladder assembly of claim 1, further comprising forward and aft extending supports for supporting said ladder assembly in a conduit.

15. The ladder assembly of claim 1, wherein at least two of said plurality of ladder segments are identical.

16. The ladder assembly of claim 1, wherein each of said ladder segments comprises four of said rungs.

17. A ladder segment for use in a multi-segment ladder assembly, said ladder segment comprising
two opposing rails and rungs pivotably mounted to said rails to allow said ladder segment to be collapsed by pivoting the rungs in a folding direction relative to the rails and moving the opposing rails closer to each other, and erected by pivoting the rungs in an unfolding direction relative to the rails and moving the opposing rails away from each other;
top and bottom rail connectors allowing interconnection of the top of said ladder segment to the bottom of another identical ladder segment;
wherein said top and bottom rail connectors are keyed, so said another identical ladder segment, when interconnected to said ladder segment, will be oriented with the unfolding direction of its rungs opposite to the unfolding direction of said rungs of said ladder segment.

18. A method of assembling a segmented ladder assembly, said segmented ladder assembly comprising
a plurality of substantially identical ladder segments, each ladder segment comprising two opposing rails and rungs pivotably mounted to said rails to allow each ladder segment to be collapsed by pivoting the rungs in a folding direction relative to the rails and moving the opposing rails closer to each other, and erected by pivoting the rungs in an unfolding direction relative to the rails and moving the opposing rails away from each other;
each ladder segment further comprising top and bottom left and right rail connectors allowing interconnection of the top of that ladder segment to the bottom of another one of said plurality of ladder segments;
wherein the top and bottom left and right rail connectors are keyed so that the left top rail connector can only engage the right bottom rail connector of another one of the ladder segments, and the right top rail connector can only engage the left bottom rail connector of the another one of the ladder segments,
said method comprising:
connecting said plurality of ladder segments to each other by way of their top and bottom rail connectors so that connected ones of said plurality of ladder segments will be oriented with the unfolding direction of their rungs opposite to each other
